(19) United States
(12) Patent Application Publication
(10) Pub. No.: US 2005/0221767 A1
(43) Pub. Date: Oct. 6, 2005

(54) High frequency module and high frequency circuit for mobile communications device

(76) Inventors: Satoshi Suga, Phoenix, AZ (US); Gerard Cunningham, Phoenix, AZ (US)

Correspondence Address: LUCE, FORWARD, HAMILTON & SCRIPPS LLP, 11988 EL CAMINO REAL, SUITE 200, SAN DIEGO, CA, 92130, US

(21) Appl. No.: 10/818,903

(22) Filed: Apr. 5, 2004

(51) Int. Cl. H04B 1/38; H04B 1/44

(52) U.S. Cl. 455/78; 455/73

(57) ABSTRACT

A high frequency module comprises a high frequency switch and a coupler. The high frequency switch selectively allows a transmission signal terminal or a reception signal terminal to be connected to an antenna terminal. The coupler is provided between the transmission signal terminal and the high frequency switch and detects transmission signals. The coupler incorporates a main line and a subline electromagnetically coupled. The subline has a width smaller than the width of the main line. Where the coupling C of the coupler is −X dB and the directivity D of the coupler is −Y dB, X is within a range of 10 to 21 inclusive and Y is 21 or greater.

### BACKGROUND OF THE INVENTION

1. Field of the Invention

The present invention relates to a high frequency module for processing transmission signals and reception signals in a communications device and to a high frequency circuit for a mobile communications device, the circuit including the high frequency module.

2. Description of the Related Art

Mobile communications devices such as cellular phones and car phones have been dramatically widespread. Some mobile communications devices comprise a high frequency module for switching between a transmission signal path and a reception signal path, which allows a single antenna to be used for both transmission and reception. Such a high frequency module comprises a high frequency switch, for example, that performs switching between transmission and reception paths. The high frequency module can be provided as a surface-mount device (SMD) wherein a plurality of components are integrated through the use of a multi-layer substrate. A high frequency module comprising such a high frequency switch is disclosed in the Published Unexamined Japanese Patent Application Heisei 9-36603 (1997), for example.

The above-mentioned high frequency switch incorporates an antenna port connected to an antenna, a transmission signal port for receiving transmission signals, and a reception signal port for outputting reception signals. Typically, a mobile communications device is designed such that transmission signals adjusted to have nearly constant levels enter the transmission signal port of the high frequency switch. The transmission signal level is adjusted in the following manner, using a power amplifier capable of controlling the gain, a directional coupler (that may be hereinafter referred to as a coupler) for detecting transmission signals, and an automatic power control circuit (that may be hereinafter referred to as an APC circuit). A transmission signal outputted from the transmission circuit is amplified by the power amplifier, and then sent to the transmission signal port of the high frequency switch through the coupler. The coupler detects the transmission signal outputted from the power amplifier and outputs a monitor signal corresponding to the transmission signal to the APC circuit. The APC circuit controls the gain of the power amplifier, in accordance with the monitor signal level, that is, in accordance with the transmission signal level, so that the output signal of the power amplifier is nearly constant.

Reductions in size and weight have been sought for mobile communications devices such as cellular phones. Accordingly, a reduction in size, integration and a reduction in the number of components have been desired for components making up the mobile communications devices, too. For this reason it has been proposed that the high frequency switch is integrated with the coupler through the use of a multi-layer substrate as disclosed in, for example, the Published Unexamined Japanese Patent Application 2002-43813, the Published Unexamined Japanese Patent Application 2002-300080, the Published Unexamined Japanese Patent Application 2002-300081 and the Published Unexamined Japanese Patent Application 2002-300082.

Reference is now made to FIG. 20 to describe a problem that arises when the high frequency switch is integrated with the coupler. FIG. 20 is a block diagram illustrating an example configuration of a high frequency circuit for a mobile communications device. The high frequency circuit of FIG. 20 comprises a high frequency switch 111 connected to an antenna 101, a transmission signal terminal 102 and a reception signal terminal 103. The transmission signal terminal 102 is connected to a transmission circuit not shown and receives a transmission signal sent from the transmission circuit. The reception signal terminal 103 is connected to a reception circuit not shown and outputs a reception signal to the reception circuit.

The high frequency switch 111 has an antenna port 111a connected to the antenna 101, and a transmission signal port 111b and a reception signal port 111c that are selectively connected to the antenna port 111a.

The high frequency circuit further comprises a power amplifier 112, a coupler 113, an APC circuit 114, a terminator 115 and an isolator 116. The power amplifier 112 has an input, an output and a gain control terminal. The input of the power amplifier 112 is connected to the transmission signal terminal 102.

The coupler 113 has an input port P01, an output port P02, a monitor port P03 and an isolation port P04. In addition, the coupler 113 has a main line S01 and a subline S02 that are a pair of strip lines electromagnetically coupled. The main line S01 has an end that is the input port P01 and the other end that is the output port P02. The subline S02 has an end that is the monitor port P03 and the other end that is the isolation port P04. The input port P01 is connected to the output of the power amplifier 112. The output port P02 is connected to an input of the isolator 116. The monitor port P03 is connected to an input of the APC circuit 114. The isolation port P04 is grounded through the terminator 115.

The APC circuit 114 has an output connected to the gain control terminal of the power amplifier 112. The APC circuit 114 controls the gain of the power amplifier 112, in accordance with the level of the monitor signal outputted from the monitor port P03 of the coupler 113, that is, in accordance with the transmission signal level, so that the output signal level of the power amplifier 112 is nearly constant.

The isolator 116 has an output connected to the port 111b of the high frequency switch 111. The isolator 116 allows signals travelling from the input to the output to pass while blocking signals travelling from the output to the input.

The high frequency circuit further comprises a filter 117 and a low-noise amplifier 118. The filter 117 has an input connected to the port 111c of the high frequency switch 111. The filter 117 has an output connected to an input of the low-noise amplifier 118. The filter 117 rejects unwanted components of reception signals. The low-noise amplifier 118 has an output connected to the reception signal terminal 103.

In the high frequency circuit of FIG. 20, the ports 111a and 111b of the high frequency switch 111 are connected to each other during transmission. At this time, the transmission signal inputted to the transmission signal terminal 102 is supplied through the power amplifier 112, the coupler 113, the isolator 116 and the high frequency switch 111, and sent out from the antenna 101. During reception, the ports 111a and 111c of the high frequency switch 111 are connected to each other. At this time, the reception signal inputted to the antenna 101 is supplied through the high frequency switch 111, the filter 117 and the low-noise amplifier 118, and outputted from the reception signal terminal 103 to the reception circuit.

In the high frequency circuit of FIG. 20 it is required that the degree of the isolation between the antenna 101 and the monitor port P03 of the coupler 113 be sufficiently great. If the degree of this isolation is not sufficient, reflection signals created by some of the transmission signals reflected off the antenna 101 reach the monitor port P03. As a result, noise is imposed on the monitor signal outputted from the monitor port P03. Consequently, it is difficult to control the output level of the power amplifier 112 with accuracy.

In the high frequency circuit of FIG. 20 the isolator 116 is inserted between the coupler 113 and the high frequency switch 111. As a result, in the high frequency circuit, the isolation between the antenna 101 and the monitor port P03 of the coupler 113 is of a sufficient value which is achieved by the isolation of the isolator 116 (−20 dB, for example) and the isolation of the coupler 113 (−30 dB, for example).

A case is herein considered in which the high frequency switch 111 of FIG. 20 is integrated with the coupler 113 through the use of a multi-layer substrate. In this case, it is impossible to insert the isolator 116 between the high frequency switch 111 and the coupler 113. Therefore, the isolation between the antenna 101 and the monitor port P03 of the coupler 113 is provided almost only by the isolation of the coupler 113. As a result, it is difficult to obtain a sufficiently great degree of isolation between the antenna 101 and the monitor port P03 of the coupler 113. This in turn will make it difficult to control the output level of the power amplifier 112 with accuracy.

A technique is disclosed in the Published Unexamined Japanese Patent Application 2002-43813 wherein, for a coupler having a main line and a subline overlaid with a dielectric layer in between, the subline has a width smaller than the width of the main line so that the entire line width of the subline is opposed to the main line with reliability. It is thereby possible to detect the transmission output with higher accuracy. However, no consideration is given for increasing the isolation of the coupler in the Published Unexamined Japanese Patent Application 2002-43813.

### OBJECT AND SUMMARY OF THE INVENTION

It is an object of the invention to provide a high frequency module for processing transmission signals and reception signals that is capable of integrating a high frequency switch with a directional coupler and achieving a sufficient isolation of the directional coupler, and to provide a high frequency circuit for a mobile communications device, the circuit including the high frequency module.

A high frequency module of the invention comprises: an antenna terminal connected to an antenna; a transmission signal terminal for receiving transmission signals; a reception signal terminal for outputting reception signals; a high frequency switch for selectively allowing the transmission signal terminal or the reception signal terminal to be connected to the antenna terminal; a directional coupler provided between the transmission signal terminal and the high frequency switch and detecting the transmission signals; and a multi-layer structure including dielectric layers and conductor layers alternately stacked. Components of the high frequency module are integrated through the use of the multi-layer structure.

According to the high frequency module of the invention, the directional coupler incorporates a main line and a subline opposed to each other with one of the dielectric layers disposed in between. The main line is inserted to a signal path between the transmission signal terminal and the high frequency switch. The subline has a width smaller than a width of the main line. The high frequency module further comprises a terminator connected to an end of the subline. Where the coupling of the directional coupler is −X dB and the directivity of the directional coupler is −Y dB, X is within a range of 10 to 21 inclusive and Y is 21 or greater.

According to the high frequency module of the invention, where the coupling of the directional coupler is −X dB and the directivity of the directional coupler is −Y dB, X is within a range of 10 to 21 inclusive and Y is 21 or greater. As a result, the isolation of the directional coupler is made great enough without reducing the function of the directional coupler for detecting transmission signals.

According to the high frequency module of the invention, Y may be 23 or greater. The characteristic impedance of the subline may be greater than the characteristic impedance of the main line. The terminator may be mounted on the multi-layer structure.

According to the high frequency module of the invention, the high frequency switch may include active devices and passive elements. The active devices may be mounted on the multi-layer structure, and at least part of the passive elements may be made up of the conductor layers. In this case, the active devices may be diodes. The passive elements made up of the conductor layers may be lumped-constant elements.

The high frequency module of the invention may further comprise: a control terminal for receiving a control signal for operating the high frequency switch; and a current limiting resistor provided between the control terminal and the high frequency switch. In addition, the current limiting resistor may be mounted on the multi-layer structure.

The high frequency module of the invention may further comprise a connecting terminal provided on an outer surface of the multi-layer structure and connected to an external circuit.

The high frequency module of the invention may further comprise a filter provided between the transmission signal terminal and the high frequency switch and rejecting unwanted components of the transmission signals.

The high frequency module of the invention may further comprise a power amplifier provided between the transmission signal terminal and the directional coupler and amplifying the transmission signals.

A high frequency circuit for a mobile communications device of the invention includes: the high frequency module of the invention; a power amplifier for amplifying transmission signals before being inputted to the directional coupler; and an automatic power control circuit for controlling a gain of the power amplifier in accordance with levels of the transmission signals detected by the directional coupler.

According to the invention, it is possible to integrate the high frequency switch with the directional coupler. In addition, where the coupling of the directional coupler is −X dB and the directivity of the directional coupler is −Y dB, X is within a range of 10 to 21 inclusive and Y is 21 or greater. As a result, sufficient isolation of the directional coupler is obtained.

Other and further objects, features and advantages of the invention will appear more fully from the following description.

### BRIEF DESCRIPTION OF THE DRAWINGS

FIG. 1 is a block diagram illustrating the configuration of a high frequency circuit for a mobile communications device of a first embodiment of the invention.

FIG. 2 is a schematic diagram illustrating an example circuit configuration of the high frequency module of the first embodiment.

FIG. 3 is a top view of the high frequency module of the first embodiment.

FIG. 4 is a side view of the high frequency module seen in the direction of arrow A of FIG. 3.

FIG. 5 is a bottom view of the high frequency module of FIG. 3.

FIG. 6 is a side view of the high frequency module seen in the direction of arrow B of FIG. 3.

FIG. 7A, FIG. 7B and FIG. 7C illustrate an example configuration of a multi-layer substrate of the first embodiment.

FIG. 8A, FIG. 8B and FIG. 8C illustrate the example configuration of the multi-layer substrate of the first embodiment.

FIG. 9A, FIG. 9B and FIG. 9C illustrate the example configuration of the multi-layer substrate of the first embodiment.

FIG. 10A, FIG. 10B and FIG. 10C illustrate the example configuration of the multi-layer substrate of the first embodiment.

FIG. 11A, FIG. 11B and FIG. 11C illustrate the example configuration of the multi-layer substrate of the first embodiment.

FIG. 12A and FIG. 12B illustrate the example configuration of the multi-layer substrate of the first embodiment.

FIG. 13 is a plot showing the frequency characteristic of the insertion loss of the transmission signal path during transmission of the high frequency module of the first embodiment.

FIG. 14 is a plot showing the frequency characteristic of the insertion loss of the reception signal path during reception of the high frequency module of the first embodiment.

FIG. 15 is a plot showing the frequency characteristic of the coupling of the coupler of the first embodiment.

FIG. 16 is a plot showing the frequency characteristic of the directivity of the coupler of the first embodiment.

FIG. 17 is a block diagram illustrating the configuration of a high frequency circuit for a mobile communications device of a second embodiment of the invention.

FIG. 18 is a schematic diagram illustrating an example circuit configuration of a high frequency module of the second embodiment.

FIG. 19 is a block diagram illustrating the configuration of a high frequency circuit for a mobile communications device of a third embodiment of the invention.

FIG. 20 is a block diagram illustrating an example configuration of a high frequency circuit of a mobile communications device.

### DESCRIPTION OF PREFERRED EMBODIMENTS

Preferred embodiments of the invention will now be described in detail with reference to the accompanying drawings.

### First Embodiment

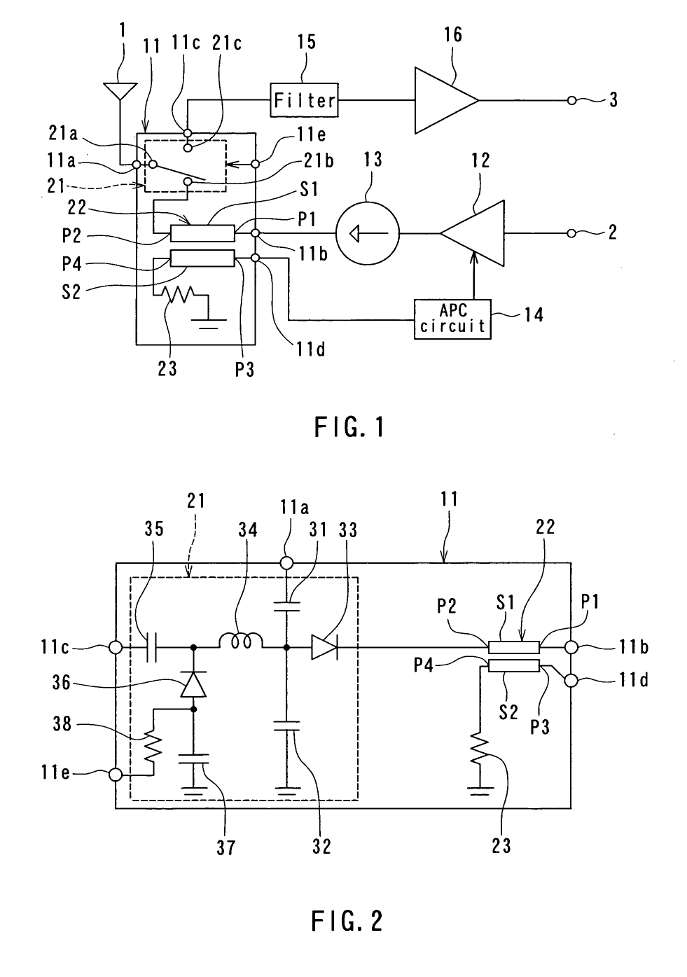

Reference is now made to FIG. 1 to describe the configuration of a high frequency module and a high frequency circuit for a mobile communications device of a first embodiment of the invention. FIG. 1 is a block diagram illustrating the configuration of the high frequency circuit of the embodiment. The high frequency module and the high frequency circuit for a mobile communications device (hereinafter simply called the high frequency circuit) of the embodiment are designed to process transmission signals and reception signals in a mobile communications device such as a cellular phone.

As shown in FIG. 1, the high frequency circuit of the embodiment comprises a transmission signal terminal 2, a reception signal terminal 3, and a high frequency module 11 of the embodiment. The transmission signal terminal 2 is connected to a transmission circuit not shown and receives a transmission signal sent from the transmission circuit. The reception signal terminal 3 is connected to a reception circuit not shown and outputs a reception signal to the reception circuit. The high frequency module 11 is connected to an antenna 1 and allows the transmission signal terminal 2 or the reception signal terminal 3 to be selectively connected to the antenna 1.

The high frequency circuit further comprises a power amplifier 12, an isolator 13, an automatic power control circuit (hereinafter referred to as APC circuit) 14, a filter 15 and a low-noise amplifier 16. The power amplifier 12 has an input, an output and a gain control terminal. The input of the power amplifier 12 is connected to the transmission signal terminal 2. The output of the power amplifier 12 is connected to an input of the isolator 13. The isolator 13 has an output connected to the high frequency module 11. The APC circuit 14 has an input connected to the high frequency module 11. The APC circuit 14 has an output connected to the gain control terminal of the power amplifier 12. The filter 15 has an input connected to the high frequency module 11. The filter 15 has an output connected to an input of the low-noise amplifier 16. The low-noise amplifier 16 has an output connected to the reception signal terminal 3.

The high frequency module 11 comprises: an antenna terminal 11a connected to the antenna 1; a transmission signal terminal 11b for receiving transmission signals; a reception signal terminal 11c for outputting reception signals; a monitor terminal 11d for outputting monitor signals; and a control terminal 11e for receiving control signals. The output of the isolator 13 is connected to the transmission signal terminal 11b. The input of the filter 15 is connected to the reception signal terminal 11c. The input of the APC circuit 14 is connected to the monitor terminal 11d.

The high frequency module 11 further comprises a high frequency switch 21, a directional coupler (hereinafter referred to as a coupler) 22, and a terminator 23. The high frequency switch 21 allows the transmission signal terminal 11b or the reception signal terminal 11c to be selectively connected to the antenna terminal 11a. The coupler 22 is provided between the transmission signal terminal 11b and the high frequency switch 21 and detects transmission signals.

The high frequency switch 21 has an antenna port 21a connected to the antenna terminal 11a, and a transmission signal port 21b and a reception signal port 21c that are selectively connected to the antenna port 21a. The coupler 22 is provided between the transmission signal port 21b and the transmission signal terminal 11b. The reception signal port 21c is connected to the reception signal terminal 11c. The control terminal 11e is connected to the high frequency switch 21.

The coupler 22 has an input port P1, an output port P2, a monitor port P3 and an isolation port P4. In addition, the coupler 22 has a main line S1 and a subline S2 that are a pair of strip lines electromagnetically coupled. The main line S1 has an end that is the input port P1 and the other end that is the output port P2. The subline S2 has an end that is the monitor port P3 and the other end that is the isolation port P4. The input port P1 is connected to the transmission signal terminal 11b. The output port P2 is connected to the transmission signal port 21b of the high frequency switch 21. The monitor port P3 is connected to the monitor terminal 11d. The isolation port P4 is grounded through the terminator 23.

The high frequency module 11 further comprises a multi-layer substrate as a multi-layer structure including dielectric layers and conductor layers alternately stacked. The components of the high frequency module 11 are integrated through the use of the multi-layer substrate. The configuration of the multi-layer substrate will be described in detail later.

The APC circuit 14 controls the gain of the power amplifier 12, in accordance with the level of the monitor signal outputted from the monitor port P3 of the coupler 22, that is, in accordance with the transmission signal level, so that the output signal level of the power amplifier 12 is nearly constant.

The isolator 13 allows signals travelling from the input to the output to pass therethrough, and intercepts signals travelling from the output to the input. The isolator 13 also has a function of attenuating harmonics of transmission signals.

The filter 15 rejects unwanted signal components of reception signals. The low-noise amplifier 16 amplifies reception signals outputted from the filter 15 and outputs the signals to the reception signal terminal 3.

The filter 15 may be any of a low-pass filter (hereinafter referred to as LPF), a band-pass filter (hereinafter referred to as BPF), a high-pass filter (hereinafter referred to as HPF) and a band-reject filter (hereinafter referred to as BRF). The filter 15 may be made up of an acoustic wave element. The acoustic wave element may be a surface acoustic wave element or a bulk acoustic wave element.

According to the high frequency circuit of the embodiment, the state of the high frequency switch 21 is switched in response to the control signal inputted to the control terminal 11e. During transmission, the ports 21a and 21b of the high frequency switch 21 are connected to each other. At this time, the transmission signal inputted to the transmission signal terminal 2 is supplied through the power amplifier 12, the isolator 13, the coupler 22 and the high frequency switch 21, and sent out from the antenna 1. During reception, the ports 21a and 21c of the high frequency switch 21 are connected to each other. At this time, the reception signal inputted to the antenna 1 is supplied through the high frequency switch 21, the filter 15 and the low-noise amplifier 16, and outputted from the reception signal terminal 3 to the reception circuit. The coupler 22 detects the transmission signal and outputs a monitor signal corresponding to the transmission signal to the APC circuit 14. The APC circuit 14 controls the gain of the power amplifier 12, in accordance with the monitor signal level, that is, in accordance with the transmission signal level, so that the output signal level of the power amplifier 12 is nearly constant.

FIG. 2 is a schematic diagram illustrating an example circuit configuration of the high frequency module 11. In this example, the high frequency switch 21 in the high frequency module 11 incorporates: a capacitor 31 having an end connected to the antenna terminal 11a; a capacitor 32 having an end connected to the other end of the capacitor 31 and the other end grounded; and a diode 33 having an anode connected to the other end of the capacitor 31 and a cathode connected to the output port P2 of the coupler 22. One of the ends of the capacitor 31 corresponds to the antenna port 21a. The cathode of the diode 33 corresponds to the transmission port 21b.

The high frequency switch 21 further incorporates: a coil 34 having an end connected to the other end of the capacitor 31; a capacitor 35 having an end connected to the other end of the coil 34 and the other end connected to the reception signal terminal 11c; a diode 36 having a cathode connected to the other end of the coil 34; a capacitor 37 having an end connected to an anode of the diode 36 and the other end grounded; and a current limiting resistor 38 having an end connected to the anode of the diode 36 and the other end connected to the control terminal 11e. The other end of the capacitor 35 corresponds to the reception signal port 21c. The diodes 33 and 36 may be PIN diodes, for example.

The high frequency switch 21 of FIG. 2 includes the diodes 33 and 36 that are active devices, and the capacitors 31, 32, 35 and 37, the coil 34, and the resistor 38 that are passive elements. Among these, the diodes 33 and 36 are mounted on the multi-layer substrate. At least part of the passive elements may be made of the conductor layers of the multi-layer substrate. The passive elements made of the conductor layers of the multi-layer substrate may be lumped-constant elements. The passive elements that are not made of the conductor layers of the multi-layer substrate are mounted on the multi-layer substrate. The main line S1 and the subline S2 of the coupler 22 are made up of the conductor layers of the multi-layer substrate. The passive elements mounted on the multi-layer substrate can be the capacitor 31 and the resistors 23 and 38, for example.

In the high frequency module 11 of FIG. 2, during transmission, the control signal applied to the control terminal 11e is high. As a result, the two diodes 33 and 36 are both brought to conduction. At this time, resonance is created by the inductance of the coil 34, the capacitors 32 and 37 and the diode 36, so that the impedance of the signal path via the coil 34 is increased and the signal path between the antenna terminal 11a and the reception signal terminal 11c is blocked. Consequently, the transmission signal inputted to the transmission signal terminal 1b passes through the diode 33 and the capacitor 31 and is sent to the antenna terminal 11a, and sent out from the antenna 1. The characteristic thus required for each of the diodes 33 and 36 is that the on-state resistance is low so as to pass a signal therethrough.

During reception, the control signal applied to the control terminal 11e is low. As a result, the two diodes 33 and 36 are both brought to non-conduction. The signal path via the diodes 33 and 36 is thereby blocked. Consequently, the reception signal inputted to the antenna 1 passes through the capacitor 31, the coil 34 and the capacitor 35 and is outputted from the reception signal terminal 11c. The characteristic thus required for each of the diodes 33 and 36 is that the off-state capacitance is low so as not to allow a signal to pass therethrough.

In the example shown in FIG. 2 the diode is used as an active device in the high frequency switch 21. Alternatively, a field-effect transistor made up of a GaAs compound semiconductor may be used in place of the diode.

In the high frequency module 11 of FIG. 2 the current limiting resistor 38 may be omitted.

In the embodiment, the main line S1 and the subline S2 of the coupler 22 are opposed to each other with the dielectric layer of the multi-layer substrate disposed in between. The main line S1 is inserted in the signal path between the transmission signal terminal 11b and the high frequency switch 21. The subline S2 has a width smaller than the width of the main line S1.

The characteristics of the coupler 22 of the embodiment will now be described. The coupling, the isolation and the directivity of the coupler 22 will be described first. Here, the levels of the signals inputted to the ports P1 to P4 of the coupler 22 and the levels of the signals outputted from the ports P1 to P4 are indicated with P1 to P4, too. The coupling, the isolation and the directivity are indicated by C (dB), I (dB) and D (dB), respectively. These characteristics are expressed by the following equations.
C=10 log (P3/P1)
I=10 log (P4/P1)=10 log (P3/P2)
D=10 log (P4/P3)

The equation of the directivity D may be converted as below, so that the directivity D is indicated by I-C.

$$\begin{matrix}D = 10 log ( P 4 / P 3 ) \\ = 10 log ( P 4 / P 1 ) - 10 log ( P 3 / P 1 ) \\ = 10 log ( P 3 / P 2 ) - 10 log ( P 3 / P 1 ) \\ = I - C\end{matrix}$$

According to the embodiment, the terminator 23 terminates the port P4 of the coupler 22. As a result, it is impossible to measure the signal level at the port P4. Therefore, according to the embodiment, the directivity D is obtained by [isolation I-coupling C], as the above equation.

As the above equation shows, the isolation I is indicated by [directivity D+coupling C].

According to the embodiment, where the coupling C of the coupler 22 is −X dB and the directivity of the coupler 22 is −Y dB, X is within a range of 10 to 21 inclusive, and Y is 21 or greater. The following is a description of the reason why the coupling C and the directivity D are defined as above. The coupling C will be described first. If X is too small, the loss of the transmission signal passing through the main line S1 is increased. On the other hand, if X is too great, the intrinsic function of the coupler 22 for detecting transmission signals is reduced. Therefore, according to the embodiment, it is defined that X is within a range of 10 to 21 inclusive, so as not to reduce the function of the coupler 22 for detecting transmission signals and not to increase the loss of transmission signals. Next, the directivity D of the coupler 22, together with the coupling C, contributes to the isolation I. However, if the contribution of the coupling C to the isolation I is great, the intrinsic function of the coupler 22 for detecting transmission signals is reduced as described above. Therefore, the contribution of the directivity D to the isolation I is preferably equal to or greater than the contribution of the coupling C to the isolation I. Therefore, according to the embodiment, Y is 21 or greater, so that the contribution of the directivity D to the isolation I is equal to or greater than the contribution of the coupling C to the isolation I. Regarding this feature, Y is preferably greater, and more specifically, preferably 23 or greater, for example.

Here, the isolation I of the coupler 22 is defined as −Z dB. Z is 31 or greater when X is within a range of 10 to 21 inclusive and Y is 21 or greater as mentioned above. Z is 33 or greater when X is within a range of 10 to 21 inclusive and Y is 23 or greater. In either of these cases, a sufficiently large isolation I is achieved.

According to the embodiment as thus described, it is possible to sufficiently increase the isolation of the coupler 22 (that is, to increase Z) without reducing the function of the coupler 22 for detecting transmission signals.

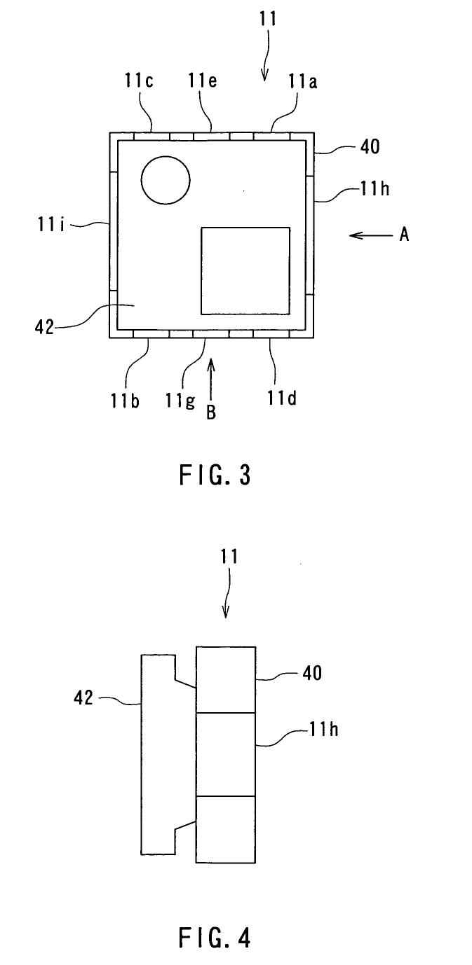

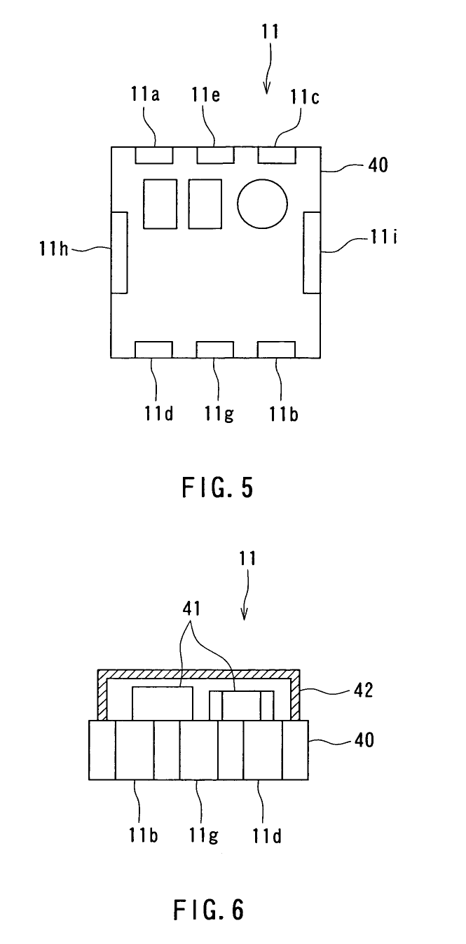

Reference is now made to FIG. 3 through FIG. 6 to describe an example of appearance of the high frequency module 11. FIG. 3 is a top view of the high frequency module 11. FIG. 4 is a side view of the high frequency module 11 seen in the direction of arrow A of FIG. 3. FIG. 5 is a bottom view of the high frequency module 11. FIG. 6 is a side view of the high frequency module 11 seen in the direction of arrow B of FIG. 3.

As shown in FIG. 3 to FIG. 6, the high frequency module 11 comprises the multi-layer substrate 40, a plurality of components 41 mounted on the top surface of the multi-layer substrate 40, and a shield case 42 covering the components 41. FIG. 6 illustrates the shield case 42 exploded. Connecting terminals to be connected to an external circuit are provided on the outer surface of the multi-layer substrate 40, the connecting terminals including the antenna terminal 11a, the transmission signal terminal 11b, the reception signal terminal 11c, the monitor terminal 11d and the control terminal 11e. In addition, three ground terminals 11g, 11h and 11i to be grounded are provided on the outer surface of the multi-layer substrate 40. The components 41 include the diodes 33 and 36, the capacitor 31 and the resistors 23 and 38, for example. The shield case 42 is made of metal. Alternatively, the components 41 may be sealed by a molded resin, instead of covering the components 41 with the shield case 42.

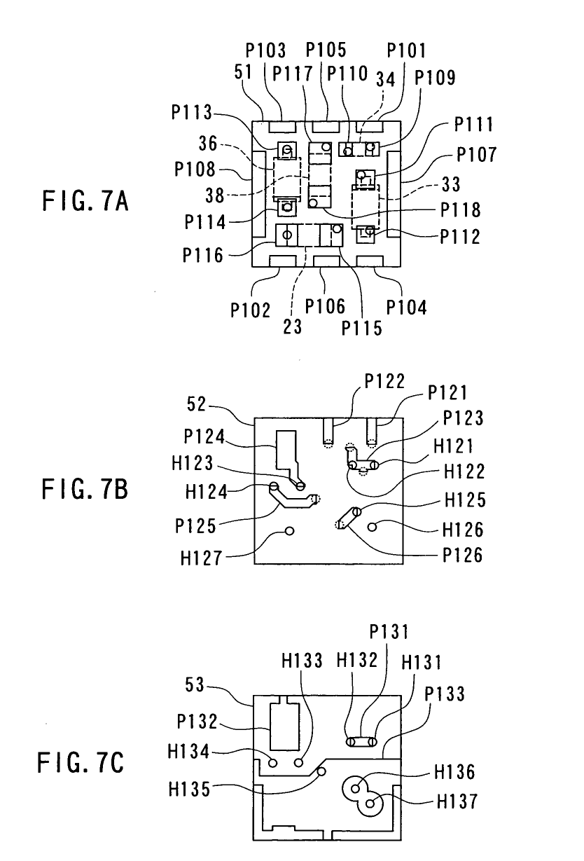

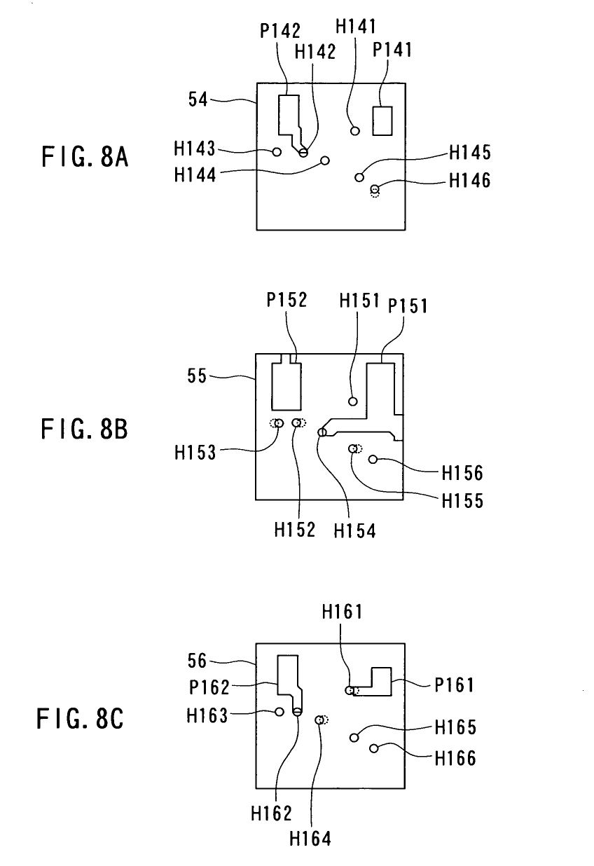

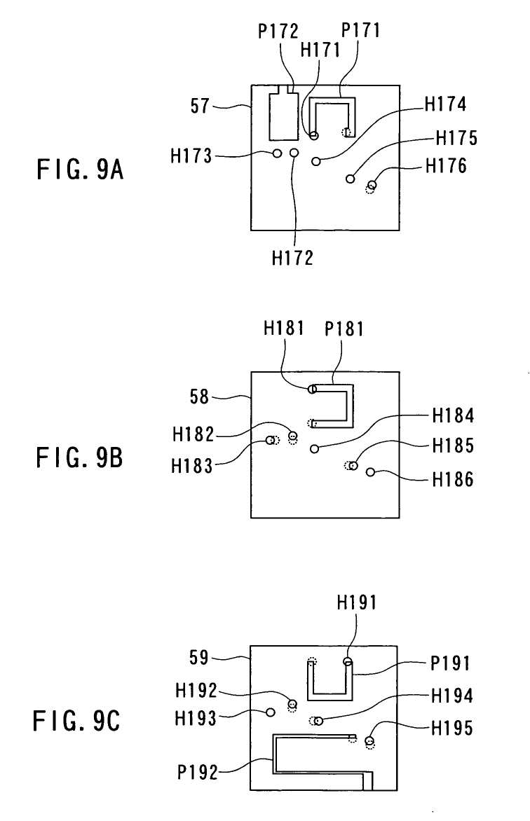

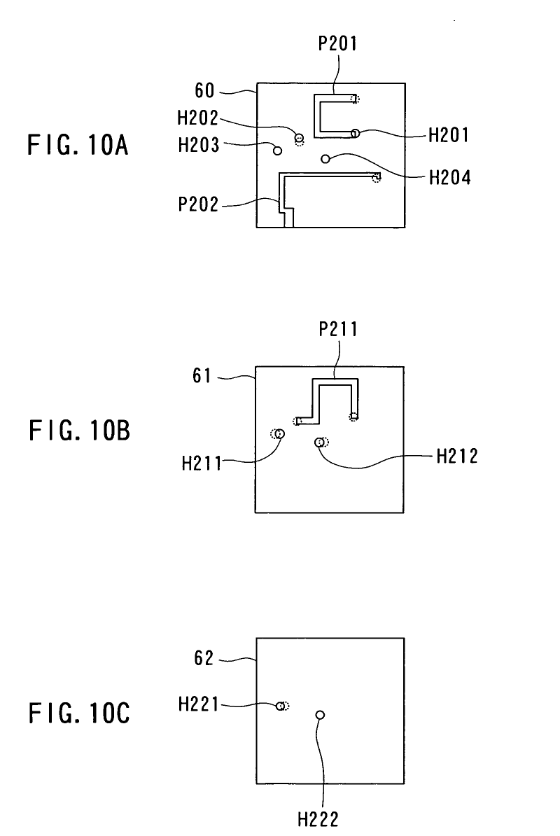

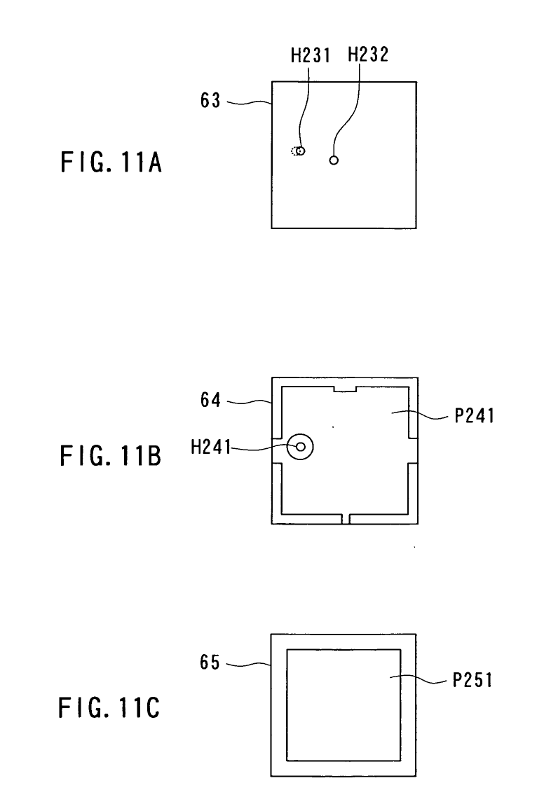

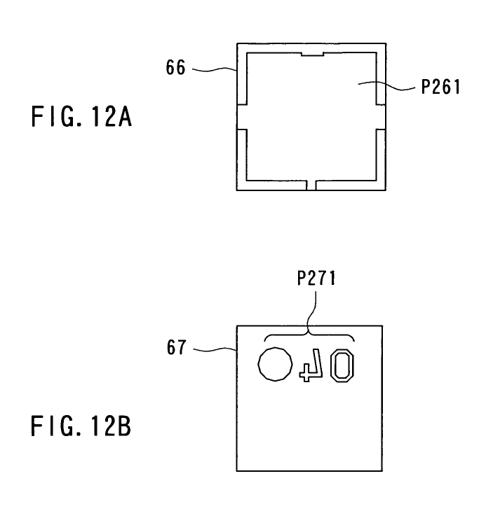

Reference is now made to FIG. 7A to FIG. 12B to describe an example configuration of the multi-layer substrate 40. In this example, the multi-layer substrate 40 comprises seventeen dielectric layers and conductor layers or markings formed on the respective dielectric layers. The dielectric layers can be made of ceramic, for example. FIG. 7A, FIG. 7B and FIG. 7C illustrate the first to third dielectric layers from the top and the conductor layers formed thereon, respectively. FIG. 8A, FIG. 8B and FIG. 8C illustrate the fourth to sixth dielectric layers from the top and the conductor layers formed thereon, respectively. FIG. 9A, FIG. 9B and FIG. 9C illustrate the seventh to ninth dielectric layers from the top and the conductor layers formed thereon respectively. FIG. 10A, FIG. 10B and FIG. 10C illustrate the tenth to twelfth dielectric layers from the top and the conductor layers formed thereon, respectively. FIG. 11A, FIG. 11B and FIG. 11C illustrate the thirteenth to fifteenth dielectric layers from the top and the conductor layers formed thereon, respectively. FIG. 12A illustrates the sixteenth dielectric layer from the top and the conductor layer formed thereon. FIG. 12B illustrates the seventeenth dielectric layer from the top and the marking formed thereon. In FIG. 7B, FIG. 8A, FIG. 8B, FIG. 8C, FIG. 9A, FIG. 9B, FIG. 9C, FIG. 10A, FIG. 10B, FIG. 10C and FIG. 11A, the dotted circles indicate the location of via holes formed in the dielectric layers located above.

Conductor portions P101 to P118 as conductor layers are provided on the top surface of the first dielectric layer 51 shown in FIG. 7A. The conductor portions P101 to P108 are connected to the terminals 11a, 11b, 11c, 11d, 11e, 11g, 11h and 11i, respectively. The ends of the capacitor 31 are connected to the conductor portions P109 and P110, respectively. The ends of the diode 33 are connected to the conductor portions P111 and P112, respectively. The ends of the diode 36 are connected to the conductor portions P113 and P114, respectively. The ends of the resistor 23 are connected to the conductor portions P115 and P116, respectively. The ends of the resistor 38 are connected to the conductor portions P117 and P118, respectively. The dielectric layer 51 has ten via holes connected to the conductor portions P109 to P118, respectively. In FIG. 7A these holes are indicated by circles.

Conductor portions P121 to P126 as conductor layers are provided on the top surface of the second dielectric layer 52 shown in FIG. 7B. The dielectric layer 52 has via holes H121 to H127. The conductor portion P121 is connected to the terminal 11a. In addition, the conductor portion P121 is connected to the conductor portion P109 through one of the via holes formed in the dielectric layer 51. The conductor portion P122 is connected to the terminal 11e. In addition, the conductor portion P122 is connected to the conductor portion P117 through one of the via holes formed in the dielectric layer 51. The conductor portion P123 is connected to the conductor portions P110 and P111 through one of the via holes formed in the dielectric layer 51. The via holes H121 and H122 are connected to the conductor portion P123. The conductor portion P124 makes up a portion of the capacitor 35. The conductor portion P124 is connected to the conductor portion P113 through one of the via holes formed in the dielectric layer 51. The via hole H123 is connected to the conductor portion P124. The conductor portion P125 is connected to the conductor portion P118 through one of the via holes formed in the dielectric layer 51. The via hole H124 is connected to the conductor portion P125. The conductor portion P126 is connected to the conductor portion P115 through one of the via holes formed in the dielectric layer 51. The via hole H125 is connected to the conductor portion P126. The via holes H126 and H127 are connected to the conductor portions P112 and P116 through the respective ones of the via holes formed in the dielectric layer 51.

Conductor portions P131 to P133 as conductor layers are provided on the top surface of the third dielectric layer 53 shown in FIG. 7C. The dielectric layer 53 has via holes H131 to H137. The via holes H131 and H132 are connected to the conductor portion P131. The via holes H131 and H132 are connected to the via holes H121 and H122, respectively. The conductor portion P132 makes up a portion of the capacitor 35. The conductor portion P132 is connected to the terminal 11c. The conductor portion P133 makes up a conductor layer for grounding. In addition, the conductor portion P133 is connected to the terminals 11g, 11h and 11i, and connected to the via hole H127. The via holes H133, H134, H136 and H137 are connected to the via holes H123, H124, H125 and H126, respectively.

Conductor portions P141 and P142 as conductor layers are provided on the top surface of the fourth dielectric layer 54 shown in FIG. 8A. The dielectric layer 54 has via holes H141 to H146. The conductor portion P141 makes up a portion of the capacitor 32. The conductor portion P141 is connected to the via hole H131. The conductor portion P142 makes up a portion of the capacitor 35. The via hole H142 is connected to the conductor portion P142. The via hole H142 is connected to the via hole H133. The via holes H141, H143, H144, H145 and H146 are connected to the via holes H132, H134, H135, H136 and H137, respectively.

Conductor portions P151 and P152 as conductor layers are provided on the top surface of the fifth dielectric layer 55 shown in FIG. 8B. The dielectric layer 55 has via holes H151 to H156. The conductor portion P151 makes up a conductor layer for grounding. The conductor portion P151 is connected to the terminal 11h. The via hole H154 is connected to the conductor portion P151. The via hole H154 is connected to the via hole H144. The conductor portion P152 makes up a portion of the capacitor 35. The conductor portion P152 is connected to the terminal 11c. The via holes H151, H152, H153, H155 and H156 are connected to the via holes H141, H142, H143, H145 and H146, respectively.

Conductor portions P161 and P162 as conductor layers are provided on the top surface of the sixth dielectric layer 56 shown in FIG. 8C. The dielectric layer 56 has via holes H161 to H166. The conductor portion P161 makes up a portion of the capacitor 32. The conductor portion P161 is connected to the via hole H151. The via hole H161 is connected to the conductor portion P161. The conductor portion P162 makes up a portion of the capacitor 35. The via hole H162 is connected to the via hole H162. The via holes H163, H164, H165 and H166 are connected to the via holes H153, H154, H155 and H156, respectively.

Conductor portions P171 and P172 as conductor layers are provided on the top surface of the seventh dielectric layer 57 shown in FIG. 9A. The dielectric layer 57 has via holes H171 to H176. The conductor portion P171 makes up a portion of the coil 34. The conductor portion P171 has an end connected to the via hole H161. The conductor portion P171 has the other end connected to the via hole H171. The conductor portion P172 makes up a portion of the capacitor 35. The conductor portion P172 is connected to the terminal 11c. The via holes H172, H173, H174, H175 and H176 are connected to the via holes H162, H163, H164, H165 and H166, respectively.

A conductor portion P181 as a conductor layer is provided on the top surface of the eighth dielectric layer 58 shown in FIG. 9B. The dielectric layer 58 has via holes H181 to H186. The conductor portion P181 makes up a portion of the coil 34. The conductor portion P181 has an end connected to the via hole H171. The conductor portion P181 has the other end connected to the via hole H181. The via holes H182, H183, H184, H185 and H186 are connected to the via holes H172, H173, H174, H175 and H176, respectively.

Conductor portions P191 and P192 as conductor layers are provided on the top surface of the ninth dielectric layer 59 shown in FIG. 9C. The dielectric layer 59 has via holes H191 to H195. The conductor portion P191 makes up a portion of the coil 34. The conductor portion P191 has an end connected to the via hole H181. The conductor portion P191 has the other end connected to the via hole H191. The conductor portion P192 makes up the subline S2 of the coupler 22. The conductor portion P192 has an end connected to the terminal 11d. The conductor portion P192 has the other end connected to the via hole H185. The via holes H192, H193, H194 and H195 are connected to the via holes H182, H183, H184 and H186, respectively.

Conductor portions P201 and P202 as conductor layers are provided on the top surface of the tenth dielectric layer 60 shown in FIG. 10A. The dielectric layer 60 has via holes H201 to H204. The conductor portion P201 makes up a portion of the coil 34. The conductor portion P201 has an end connected to the via hole H191. The conductor portion P201 has the other end connected to the via hole H201. The conductor portion P202 makes up the main line S1 of the coupler 22. The conductor portion P202 has an end connected to the terminal 11b. The conductor portion P202 has the other end connected to the via hole H195. The via holes H202, H203 and H204 are connected to the via holes H192, H193 and H194, respectively.

A conductor portion P211 as a conductor layer is provided on the top surface of the eleventh dielectric layer 61 shown in FIG. 10B. The dielectric layer 61 has via holes H211 and H212. The conductor portion P211 makes up a portion of the coil 34. The conductor portion P211 has an end connected to the via hole H201. The conductor portion P211 has the other end connected to the via hole H202. The via holes H211 and H212 are connected to the via holes H203 and H204, respectively.

The twelfth dielectric layer 62 shown in FIG. 10C has via holes H221 and H222. The via holes H221 and H222 are connected to the via holes H211 and H212.

The thirteenth dielectric layer 63 shown in FIG. 11A has via holes H231 and H232. The via holes H231 and H232 are connected to the via holes H221 and H222.

A conductor portion P241 as a conductor layer is provided on the top surface of the fourteenth dielectric layer 64 shown in FIG. 11B. The dielectric layer 64 has a via hole H241. The conductor portion P241 makes up a conductor layer for grounding. The conductor portion P241 is connected to the terminals 11g, 11h and 11i. In addition, the conductor portion P241 is connected to the via hole H232. The via hole H241 is connected to the via hole 231.

A conductor portion P251 as a conductor layer is provided on the top surface of the fifteenth dielectric layer 65 shown in FIG. 11C. The conductor portion P251 makes up a portion of the capacitor 37. The conductor portion P251 is connected to the via hole H241.

A conductor portion P261 as a conductor layer is provided on the top surface of the sixteenth dielectric layer 66 shown in FIG. 12A. The conductor portion P261 makes up a conductor layer for grounding. The conductor portion P261 is connected to the terminals 11g, 11h and 11i.

A marking P271 is provided on the top surface of the seventeenth dielectric layer 67 shown in FIG. 12B.

The multi-layer substrate 40 can be fabricated through the following method. Ceramic slurry is applied to a film of polyethylene terephthalate and dried to form a dielectric sheet to be dielectric layers. Next, holes to be used as via holes are formed in the dielectric sheet as required. Next, conductor paste is printed on the dielectric sheet by a printing process to form conductor layers having specific patterns. At the same time, the holes to be the via holes are filled with conductor paste to thereby form the via holes. Next, a plurality of dielectric sheets having the conductor layers and the via holes formed in the above-mentioned manner are dried and then stacked and integrated by hot pressing. Next, the layered structure thus obtained is cut into portions to be the individual multi-layer substrates 40. Next, the layered structures thus divided are fired in an electric furnace. Next, connecting terminals to be connected to an external circuit are transferred to the peripheries of the layered structures. The layered structures are then fired and furthermore, plating is performed on the layered structures. The multi-layer substrates 40 are thus completed. The components 41 are mounted on each of the multi-layer substrates 40, and furthermore, the shield case 42 is attached thereto. The high frequency module 11 is thus completed.

According to the embodiment as thus described, the high frequency switch 21 is integrated with the coupler 22 through the use of the multi-layer substrate 40. As a result, three-dimensional alignment of the high frequency switch 21 and the coupler 22 is achieved and it is thereby possible to reduce the size of the high frequency module 11 including the high frequency switch 21 and the coupler 22. Conventional high frequency switch and coupler that are discrete components have dimensions as follows, for example. The high frequency switch has a length of 3.5 millimeters (mm), a width of 3.5 mm and a height of 1.9 mm. The coupler has a length of 1.6 mm, a width of 0.8 mm and a height of 0.8 mm. In contrast, it is possible that the high frequency module 11 of the embodiment has a length of 3.5 mm, a width of 3.5 mm and a height of 1.9 mm that are the same as the dimensions of the conventional discrete high frequency switch although the high frequency module 11 includes the high frequency switch 21 (including the resistor 38), the coupler 22 and the resistor 23.

According to the embodiment, at least part of the passive elements that the high frequency module 11 includes is incorporated in the multi-layer substrate 40. In addition, the passive elements of the switch incorporated in the multi-layer substrate 40 are not distributed-constant circuit elements but the lumped-constant circuit elements such as the coils and the capacitors. For the distributed-constant circuit elements, a length depending on the signal wavelength is required, such as a quarter of the signal wavelength. Therefore, if the distributed-constant circuit elements are used as the passive elements, it may be difficult to reduce the dimensions of the multi-layer substrate 40. According to the embodiment, in contrast, the lumped-constant circuit elements are used as the passive elements so that a reduction in size of the multi-layer substrate 40 is achieved.

According to the embodiment, where the coupling C of the coupler 22 is −X dB and the directivity D of the coupler 22 is −Y dB, X is within a range of 10 to 21 inclusive, and Y is 21 or greater and preferably 23 or greater. To achieve such characteristics of the coupler 22, it is particularly required to improve the directivity of the coupler 22, that is, to increase Y. A method of achieving the characteristics of the coupler 22 of the embodiment will now be described. For the coupler 22 using strip lines as the embodiment, according to the principle, when the characteristic impedance of the strip lines is equal to the load resistance, the reflection of signals between the coupler 22 and the load is the least and the loss of the coupler 22 is small. According to the principle, when the length of the region in which the main line S1 is opposed to the subline S2 is equal to a quarter of the signal wavelength, no signal is generated at the isolation port P4 and the directivity of the coupler 22 is improved. However, for the actual coupler 22 formed in a layered structure, it is difficult to design ideal strip lines, and the input/output impedance of the components connected to the coupler 22 is not always equal to the characteristic impedance of the strip lines (50 ohms, for example), so that reflection occurs. As a result, signals leak into the isolation port P4, and it is difficult to sufficiently increase the directivity of the coupler 22.

To increase the directivity of the coupler 22 (that is, to increase Y), changing the characteristic impedance of the strip lines making up the coupler 22 is considered. Here, each of the main line S1 and the subline S2 of the coupler 22 is made up of the middle conductor layer of a triplate strip line. The distance between upper and lower two conductor layers for grounding of the triplate strip lines is unchanged and the width of the middle conductor layer is adjusted so as to change the characteristic impedance of the strip lines.

Since the main line S1 of the coupler 22 is connected to the transmission circuit, it is required that the output impedance of the main line S1 is matched to 50 ohms, for example. Therefore, it is not preferred to change the width of the main line S1. In contrast, the subline S2 is only used to detect transmission signals, and therefore it is possible to change the characteristic impedance. According to the embodiment, the subline S2 is made smaller in width than the main line S1 to increase the characteristic impedance of the subline S2. Leakage of signals from the main line S1 to the isolation port P4 of the subline S2 is thereby suppressed.

If the width of the subline S2 is reduced, the coupling of the coupler 22 is weakened (that is, X is increased). However, increasing the length of the region in which the main line S1 is opposed to the subline S2 prevents this weakening of the coupling of the coupler 22. Even if the length of this region is increased, the relationship between the characteristic impedances of the lines S1 and S2 remains the same, so that leakage of signals into the isolation port P4 will not increase.

As described above, the directivity and the isolation of the coupler 22 are improved by making the width of the subline S2 smaller than the width of the main line S1. However, there exists a minimum value of the line width that can be achieved by the printing process, so that there is limitation to reducing the width of the subline S2. Therefore, regarding the balance between this manufacturing limitation and the need for improving the characteristics of the coupler, it is preferable that the value obtained by dividing the width of the subline S2 by the width of the main line S1 be within a range of 0.9 to 0.2 inclusive. If the characteristic impedance of the main line S1 is 50 ohms, the characteristic impedance of the subline S2 is within a range of approximately 54 to 80 ohms inclusive when the value obtained by dividing the width of the subline S2 by the width of the main line S1 is within a range of 0.9 to 0.2 inclusive.

As thus described, the directivity and the isolation of the coupler 22 are improved by making the width of the subline S2 smaller than the width of the main line S1. However, this is not sufficient yet. Therefore, consideration will now be given to the terminator 23 connected to the isolation port P4 of the subline S2. As described above, the directivity and the isolation of the coupler 22 are improved by changing the characteristic impedance of the subline S2. Moreover, it is possible that the impedance of the subline S2 seen from the main line S1 is changed by modifying the resistance of the terminator 23. Consequently, it is possible that the directivity and the isolation of the coupler 22 are improved by changing the resistance of the terminator 23. However, if the resistance of the terminator 23 is changed, the output impedance of the monitor port P3 is greatly changed. Therefore, there is a limit to the amount of change in the resistance of the terminator 23.

Typically, a discrete coupler is optimized for use in the system in which the characteristic impedance is 50 ohms, so that the external terminator connected to the coupler is a resistor having a resistance of 50 ohms. However, according to the embodiment, the terminator 23, together with the coupler 22, is integrated with the high frequency module 11. As a result, the directivity and the isolation of the coupler 22 are improved by optimizing the resistance of the terminator 23 in combination with the characteristic impedance of the subline S2.

The resistance of the terminator 23 can be optimized in the following manner. Structural simulation of the coupler 22 is performed and the characteristics of the coupler 22 are outputted as S parameters. Next, a circuit simulator is used to add the resistance of the terminator 23 to the result of the structural simulation and the characteristics of the coupler 22 are simulated. In this step the resistance of the terminator 23 is changed within the range in which the characteristic of the coupler 22 is not affected, that is, the range in which the reflection loss at the monitor port P3 is 10 dB or greater, for example. The resistance of the terminator 23 is thereby optimized so that the isolation of the coupler 22 (the value of Z) is maximum. The resistance of the terminator 23 obtained by this simulation is the actual resistance of the terminator 23.

The optimum resistance of the terminator 23 is within a range of approximately 30 to 47 ohms inclusive, for example, when the value obtained by dividing the width of the subline S2 by the width of the main line S1 is within a range of 0.9 to 0.2 inclusive and the characteristic impedance of the subline S2 is within a range of approximately 54 to 80 ohms inclusive, as described above.

Although the foregoing description illustrates the case in which the width of the subline S2 is changed to alter the characteristic impedance of the subline S2, it is possible to change the characteristic impedance of the subline S2 by changing the distance between the upper and lower two conductor layers for grounding of the triplate strip lines.

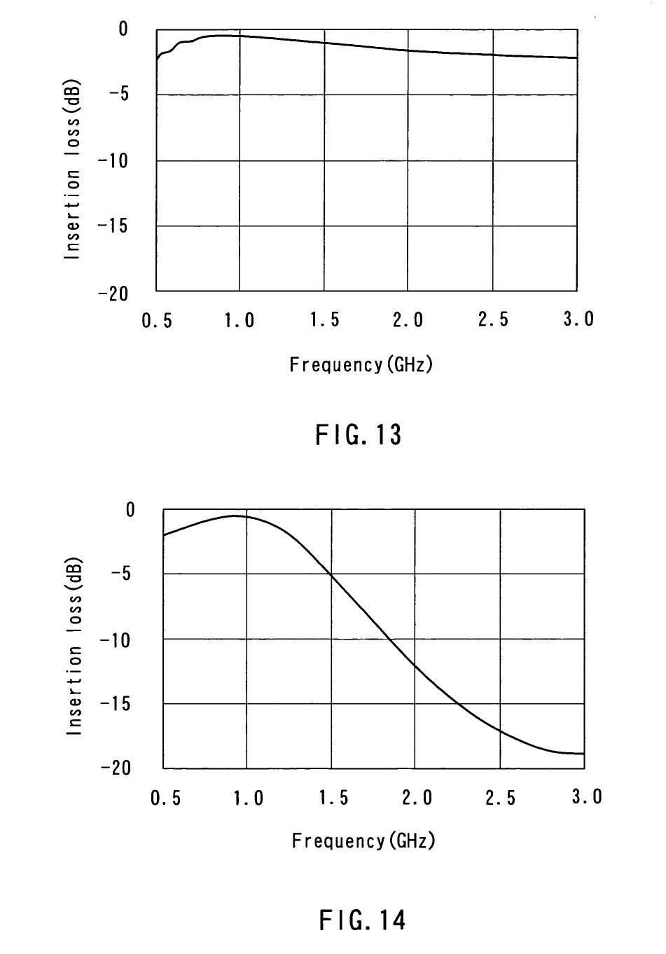

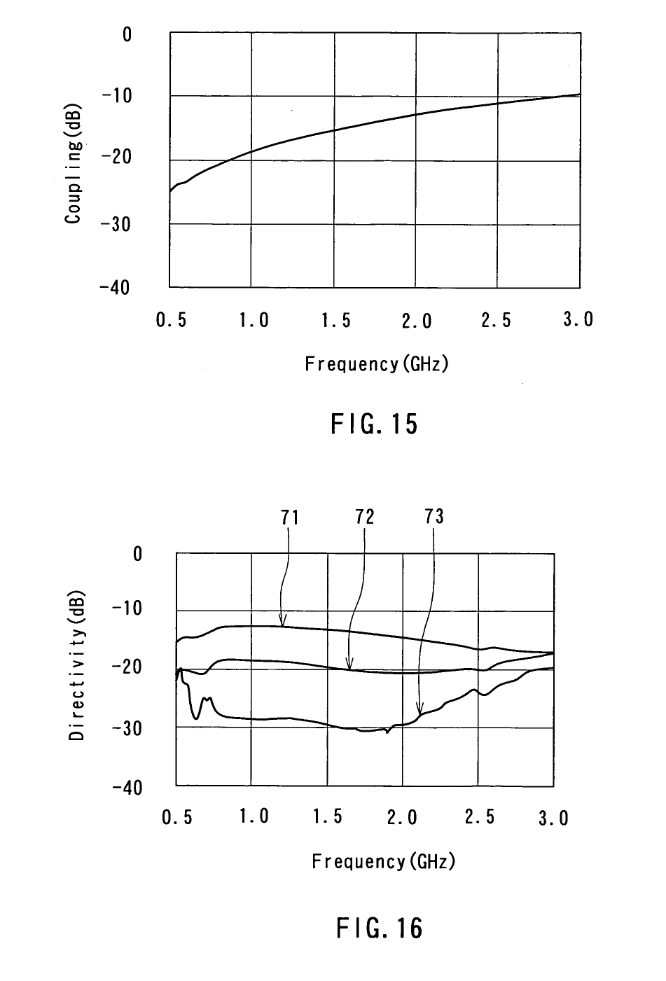

Reference is now made to FIG. 13 to FIG. 16 to describe an example of the characteristics of the high frequency module 11 of the embodiment. FIG. 13 is a plot showing the frequency characteristics of the insertion loss of the transmission signal path during transmission of the high frequency module 11. FIG. 14 is a plot showing the frequency characteristics of the insertion loss of the reception signal path during reception of the high frequency module 11. FIG. 15 is a plot showing the frequency characteristics of the coupling of the coupler 22. FIG. 16 is a plot showing the frequency characteristics of the directivity of the coupler 22. FIG. 13 to FIG. 16 show the example designed for use in a frequency band of 0.8 to 0.9 GHz.

In this example, as shown in FIG. 15, the coupling of the coupler 22 is within a range of −19 to −21 dB inclusive in the above-mentioned usable frequency band.

In FIG. 16 numeral 71 indicates the directivity of the coupler 22 when the width of the main line S1 is equal to the width of the subline S2. Numeral 72 indicates the directivity of the coupler 22 when the value obtained by dividing the width of the subline S2 by the width of the main line S1 is 0.5, and the characteristic impedance of the subline S2 is 63 ohms while the resistance of the terminator 23 is not optimized but the resistance of the terminator 23 is 51 ohms. Numeral 73 indicates the directivity of the coupler 22 when the value obtained by dividing the width of the subline S2 by the width of the main line S1 is 0.5, and the characteristic impedance of the subline S2 is 63 ohms, and furthermore, the resistance of the terminator 23 is optimized to be 36 ohms.

As shown in FIG. 16, the directivity of the coupler 22 is improved by making the width of the subline S2 smaller than the width of the main line S1, but this is not sufficient yet. However, optimizing the resistance of the terminator 23 can further improve the directivity of the coupler 22. The characteristic thereby obtained is that, where the directivity of the coupler 22 is −Y dB in the usable frequency band, Y is 23 or greater. In this example, Y is within a range of 27 to 29 inclusive in the usable frequency band.

Although the frequency characteristic of the isolation of the coupler 22 of the above-described example is not shown, the isolation is obtained by adding the directivity to the coupling, as described above.

According to the embodiment as thus described, the high frequency switch 21 is integrated with the coupler 22 through the use of the high frequency module 11. As a result, reductions in size and weight of the high frequency circuit are achieved. According to the embodiment, a sufficient isolation of the coupler 22 is obtained.

### Second Embodiment

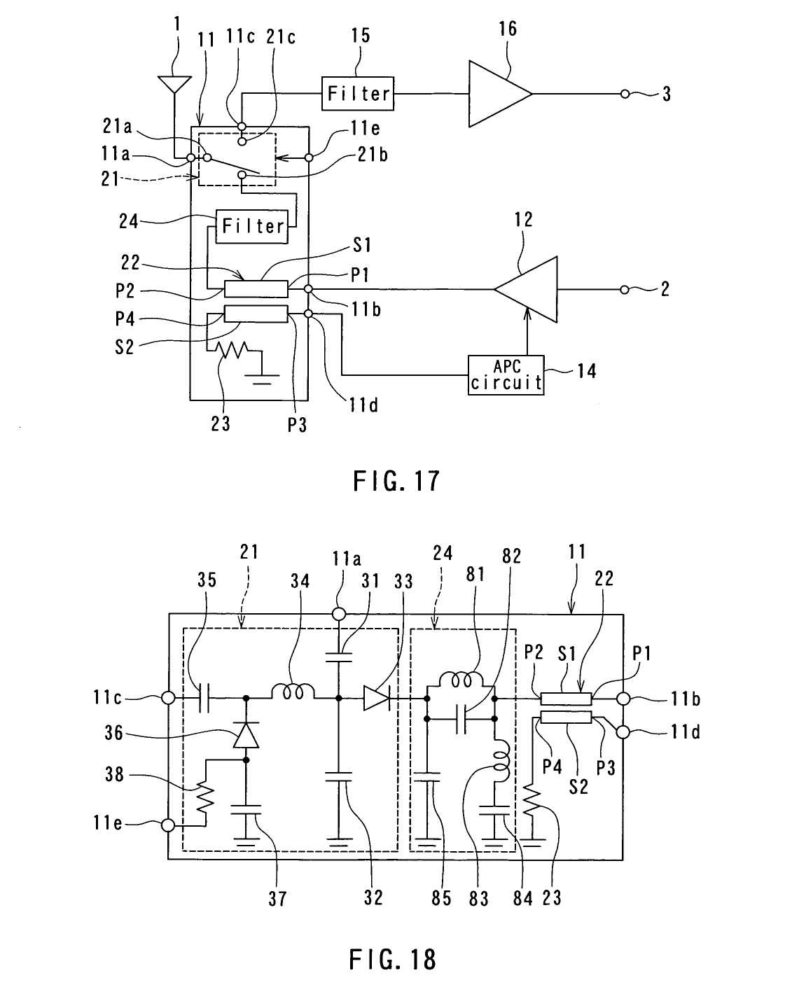

Reference is now made to FIG. 17 and FIG. 18 to describe a high frequency module and a high frequency circuit of a second embodiment of the invention. FIG. 17 is a block diagram illustrating the configuration of the high frequency circuit of the embodiment. FIG. 18 is a schematic diagram illustrating an example of the circuit configuration of the high frequency module of the embodiment.

As shown in FIG. 17, the high frequency module 11 of the embodiment comprises a filter 24 that is provided between the transmission signal terminal 11b and the high frequency switch 21 and that rejects unwanted components of transmission signals. To be specific, the filter 24 is provided between the output port P2 of the coupler 22 and the transmission signal port 21b of the high frequency switch 21. According to the second embodiment, the isolator 13 is not provided, but the output of the power amplifier 12 is connected to the transmission signal terminal 11b of the high frequency module 11.

The filter 24 may be either an LPF or a BPF. The filter 24 may be made up of an acoustic wave element. The acoustic wave element may be a surface acoustic wave element or a bulk acoustic wave element.

FIG. 18 illustrates an example circuit configuration of the high frequency module 11 where the filter 24 is an LPF. In this case, the filter 24 has a function of attenuating harmonics of transmission signals. In this example, the filter 24 is provided between the output port P2 of the coupler 22 and the cathode of the diode 33 of the high frequency switch 21. The filter 24 incorporates: a coil 81 having an end connected to the output port P2 and the other end connected to the cathode of the diode 33; a capacitor 82 having an end connected to the output port P2 and the other end connected to the cathode of the diode 33; a coil 83 having an end connected to the output port P2; a capacitor 84 having an end connected to the other end of the coil 83 and the other end grounded; and a capacitor 85 having an end connected to the cathode of the diode 33 and the other end grounded.

According to the second embodiment, the components of the filter 24 are made up of the conductor layers of the multi-layer substrate 40 and integrated with the multi-layer substrate 40. According to the second embodiment, although the filter 24 is added to the components of the high frequency module 11, the size of the high frequency module 11 is almost the same as that of the first embodiment. On the other hand, according to the second embodiment, the isolator 13 is excluded, so that the size and weight of the high frequency circuit are smaller, compared to the first embodiment.

The remainder of configuration, functions and effects of the second embodiment are similar to those of the first embodiment.

### Third Embodiment

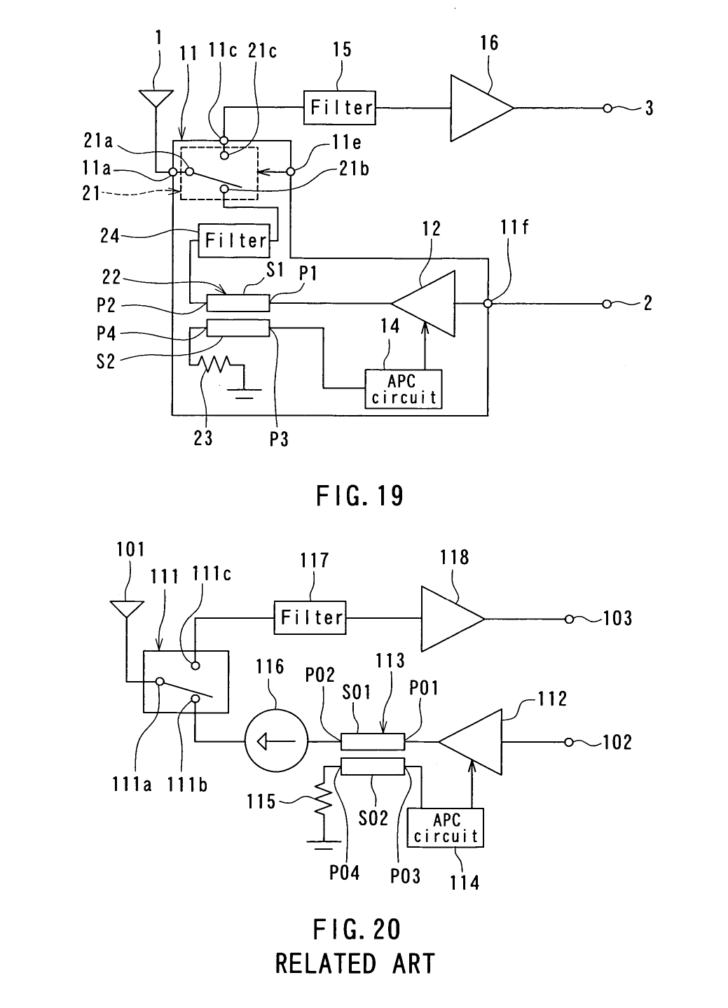

Reference is now made to FIG. 19 to describe a high frequency module and a high frequency circuit of a third embodiment of the invention. FIG. 19 is a block diagram illustrating the configuration of the high frequency circuit of the embodiment.

According to the third embodiment, the high frequency module 11 includes the power amplifier 12 and the APC circuit 14, in addition to the components of the second embodiment. The high frequency module 11 does not comprise the transmission signal terminal 11b and the monitor terminal 11d of the second embodiment but comprises a transmission signal terminal 11f instead. The transmission signal terminal 11f is connected to the transmission signal terminal 2 of the high frequency circuit and to the input of the power amplifier 12. The output of the power amplifier 12 is connected to the input port P1 of the coupler 22. The input of the APC circuit 14 is connected to the monitor port P3 of the coupler 22.

The power amplifier 12 and the APC circuit 14 include active devices and passive elements. The active devices are mounted on the multi-layer substrate 40. At least part of the passive elements may be made up of the conductor layers of the multi-layer substrate 40. The passive elements that are not made up of the conductor layers of the multi-layer substrate 40 are mounted on the multi-layer substrate 40.

According to the third embodiment, the size and weight of the high frequency circuit are further reduced. The remainder of configuration, functions and effects of the third embodiment are similar to those of the second embodiment. Alternatively, the third embodiment may be modified such that the high frequency module 11 does not include the APC circuit 14 but includes the power amplifier 12.

The present invention is not limited to the foregoing embodiments but can be implemented in various ways. For example, the multi-layer structure is not limited to the multi-layer substrate wherein the dielectric layers are made of ceramic but may be a substrate wherein the dielectric layers are made of resin.

Obviously many modifications and variations of the present invention are possible in light of the above teachings. It is therefore to be understood that within the scope of the appended claims the invention may be practiced otherwise than as specifically described.

1. A high frequency module comprising:
an antenna terminal connected to an antenna;
a transmission signal terminal for receiving transmission signals;
a reception signal terminal for outputting reception signals;
a high frequency switch for selectively allowing the transmission signal terminal or the reception signal terminal to be connected to the antenna terminal;
a directional coupler provided between the transmission signal terminal and the high frequency switch and detecting the transmission signals; and
a multi-layer structure including dielectric layers and conductor layers alternately stacked, wherein:
components of the high frequency module are integrated through the use of the multi-layer structure;
the directional coupler incorporates a main line and a subline opposed to each other with one of the dielectric layers disposed in between;
the main line is inserted to a signal path between the transmission signal terminal and the high frequency switch;
the subline has a width smaller than a width of the main line;
the high frequency module further comprises a terminator connected to an end of the subline; and
where a coupling of the directional coupler is −X dB and a directivity of the directional coupler is −Y dB, X is within a range of 10 to 21 inclusive and Y is 21 or greater.

2. The high frequency module according to claim 1, wherein Y is 23 or greater.

3. The high frequency module according to claim 1, wherein a characteristic impedance of the subline is greater than a characteristic impedance of the main line.

4. The high frequency module according to claim 1, wherein the terminator is mounted on the multi-layer structure.

5. The high frequency module according to claim 1, wherein:
the high frequency switch includes active devices and passive elements;
the active devices are mounted on the multi-layer structure; and
at least part of the passive elements is made up of the conductor layers.

6. The high frequency module according to claim 5, wherein the active devices are diodes.

7. The high frequency module according to claim 5, wherein the passive elements made up of the conductor layers are lumped-constant elements.

8. The high frequency module according to claim 1, further comprising:
a control terminal for receiving a control signal for operating the high frequency switch; and a current limiting resistor provided between the control terminal and the high frequency switch, wherein the current limiting resistor is mounted on the multi-layer structure.

9. The high frequency module according to claim 1, further comprising a connecting terminal provided on an outer surface of the multi-layer structure and connected to an external circuit.

10. The high frequency module according to claim 1, further comprising a filter provided between the transmission signal terminal and the high frequency switch and rejecting unwanted components of the transmission signals.

11. The high frequency module according to claim 1, further comprising a power amplifier provided between the transmission signal terminal and the directional coupler and amplifying the transmission signals.

12. A high frequency circuit for a mobile communications device, the high frequency circuit including a high frequency module that comprises:
an antenna terminal connected to an antenna;
a transmission signal terminal for receiving transmission signals;
a reception signal terminal for outputting reception signals;
a high frequency switch for selectively allowing the transmission signal terminal or the reception signal terminal to be connected to the antenna terminal;
a directional coupler provided between the transmission signal terminal and the high frequency switch and detecting the transmission signals; and
a multi-layer structure including dielectric layers and conductor layers alternately stacked, wherein
components of the high frequency module are integrated through the use of the multi-layer structure, the high frequency circuit further including:
a power amplifier for amplifying transmission signals before being inputted to the directional coupler; and
an automatic power control circuit for controlling a gain of the power amplifier in accordance with levels of the transmission signals detected by the directional coupler, wherein:
the directional coupler incorporates a main line and a subline opposed to each other with one of the dielectric layers disposed in between;
the main line is inserted to a signal path between the transmission signal terminal and the high frequency switch;
the subline has a width smaller than a width of the main line;
the high frequency module further comprises a terminator connected to an end of the subline; and
where a coupling of the directional coupler is −X dB and a directivity of the directional coupler is −Y dB, X is within a range of 10 to 21 inclusive and Y is 21 or greater.
